(19) United States
(12) Patent Application Publication
(10) Pub. No.: US 2022/0099441 A1
(43) Pub. Date: Mar. 31, 2022

(54) Level With Self-Storing Cleaning Tool

(71) Applicant: APEX BRANDS, INC., Apex, NC (US)

(72) Inventors: Matthew Poppe, Raleigh, NC (US); Sujith Sunny, Huntersville, NC (US); Bryan Washburn, Charlotte, NC (US); Anthony Katsaros, Durham, NC (US)

(21) Appl. No.: 17/490,056

(22) Filed: Sep. 30, 2021

Related U.S. Application Data
(60) Provisional application No. 63/085,574, filed on Sep. 30, 2020.

(51) Int. Cl. G01C 9/34; A46B 15/00; A47L 25/00

(52) U.S. Cl. CPC G01C 9/34; A46B 15/0095; A46B 2200/3073; A46B 15/0055; A47L 25/00; A46B 15/0081

(57) ABSTRACT

A level device may include a housing having a top face, a bottom face, a first end and a second end. The housing may include a receiving space disposed at the first end. The device may further include a vial assembly and an end cap. The vial assembly may include one or more spirit or bubble levels disposed in the housing to indicate conditions of level or plumb relative to orientation of the top or bottom faces. The end cap may be configured to be removably retained in the receiving space. The end cap may include a cleaning tool disposed at a portion of the end cap and configured to be retained in the receiving space when the end cap is operably coupled to the level.

### TECHNICAL FIELD

Example embodiments generally relate to angle measuring devices, and particularly relate to a spirit or bubble level that with a cleaning system integrated therein.

### BACKGROUND

Measuring devices such as bubble levels (or spirit levels) have been around for a very long time, and are common measuring tools used in numerous contexts to obtain angular measurements or to ensure that surfaces are level or plumb. Most commonly, the bubble level is provided in a cylindrical vial, and the vial is attached to a flat surface so that when the bubble is in the center of the vial, the surface (which may be laid on another surface being measured for level or plumb) is known to be level. The attachment between the cylindrical vial and the flat surface is typically a fixed attachment. Level and plumb may be measured by the same device with multiple vials provided with different angles (e.g., 90 degree rotation) relative to perpendicular flat surfaces.

Because levels are often used in construction settings in which dirt, gravel, tile grout, dust, and other materials or debris are present, it is not uncommon for such materials to build up on various surfaces of the level, or on the vials. This build up can make the tool difficult to use. For example, when vials become covered in dirt or debris they are difficult to see. When machined surfaces become covered with grout they will impact the level's ability to show true level.

Currently, most users will use a rag or cloth to clean off their level. However, this is often an ineffective solution. Rags are flimsy and lack the rigidity necessary to get into some corners or spaces that require cleaning. Rags are also difficult to clean themselves and eventually must be discarded and replaced with new ones when they become so dirty they can no longer be used to clean.

Accordingly, it may be desirable to improve device designs in order to provide a more robust and convenient cleaning solution for the device.

### BRIEF SUMMARY OF SOME EXAMPLES

Some example embodiments may enable the provision of a level (e.g., a bubble level). The device may include a housing having a top face, a bottom face, a first end and a second end. The housing may include a receiving space disposed at the first end. The device may further include a vial assembly and an end cap. The vial assembly may include one or more spirit or bubble levels disposed in the housing to indicate conditions of level or plumb relative to orientation of the top or bottom faces. The end cap may be configured to be removably retained in the receiving space. The end cap may include a cleaning tool disposed at a portion of the end cap and configured to be retained in the receiving space when the end cap is operably coupled to the level.

In another example embodiment, the removable end cap for a level device having a housing that includes a receiving space disposed at an end portion of the housing is provided. The end cap may include an interface portion configured to mate with the receiving space, and a cleaning tool operably coupled to the interface portion. The cleaning tool may be configured to be retained entirely within the receiving space when the end cap is mated with the housing.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a level device in accordance with an example embodiment;

FIG. 2 shows a perspective view of a cleaning tool in a detached position in accordance with an example embodiment;

FIG. 3 illustrates a perspective view of an alternative form for the cleaning tool in accordance with an example embodiment;

FIG. 4 illustrates a perspective view of a multi-purpose cleaning tool in accordance with an example embodiment; and

FIG. 5 is a partially exploded view of some components of a level device having a cleaning tool in accordance with an example embodiment;

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may relate to the provision of a level (e.g., a bubble level) that may have an improved configuration by including a cleaning system that is integrated therein. In this regard, for example, at least one end cap of the level may be detachable and incorporate cleaning tools therein. In some cases, both end caps of the protective housing of the level may be detachable and incorporate such cleaning tools.

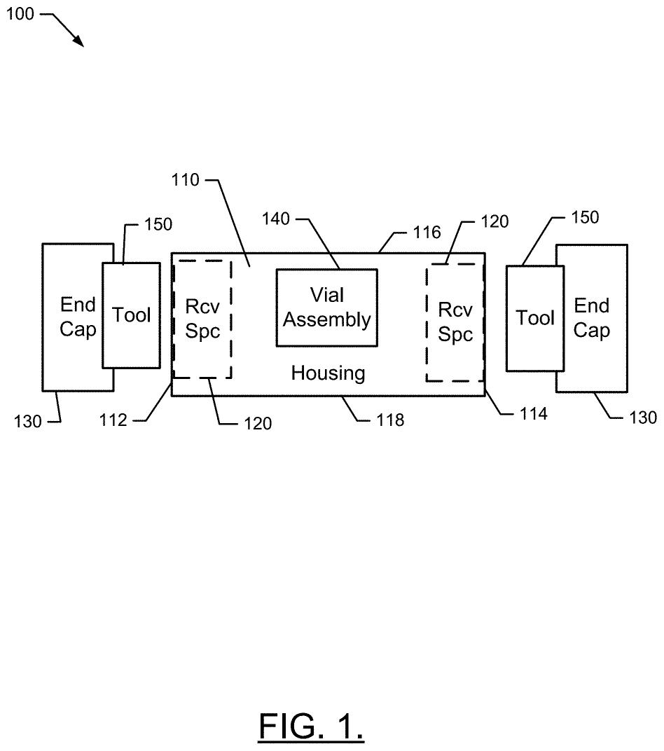

FIG. 1 illustrates a block diagram of a level (e.g., a bubble level) of an example embodiment. The level 100 includes a housing 110 that comprises an elongate container having at least one (and typically multiple) flat surfaces forming various edges thereof. In some cases, the elongate container of the housing 110 may be formed as a rectangular prism having a first end 112, a second end 114, a top face 116 and a bottom face 118. The top face 116 and the bottom face 118 may each be substantially flat or planar surfaces that are substantially parallel to each other. The first end 112 and the second end 114 may also lie in planes that are parallel to each other and spaced apart from each other by the length of the top and bottom faces 116 and 118. The planes in which the first and second ends 112 and 114 lie may be substantially perpendicular to the planar surfaces of the top face 116 and the bottom face 118. Although not specifically identified in FIG. 1, the housing 110 may also include a front face and a rear face that are substantially parallel to each other, and substantially perpendicular to the planar surfaces of the top face 116 and the bottom face 118 and the planes in which the first and second ends 112 and 114 lie.

In an example embodiment, the housing 110 may be hollow along its longitudinal length thereby defining a hollow tube having a substantially rectangular cross section along the length of the housing 110. Alternatively, end portions (i.e., proximate to the first and second ends 112 and 114) may be hollow. Regardless of whether such hollow portions are continuous along the length of the housing 110 or confined merely to end portions of the housing 110, hollow portions proximate to the first and second ends 112 and 114 may be referred to as receiving spaces (Rcv Spc) 120, which are shown in FIG. 1.

In an example embodiment, the receiving spaces 120 may be configured to receive or otherwise accommodate and interface with an end cap 130 such that the end cap 130 is manually removable from the receiving space 120. The end cap 130 may include an interface portion that is configured to fit inside the receiving space 120 on a corresponding one of either the first end 112 or the second end 114. Thus, for example, the interface portion could include a simple friction based fitting based on a substantially similar shape and size of the outer surface of the interface portion and an inner surface of the receiving space 120. However, in other cases, cooperating surfaces, protrusions, grooves, detents, orifices, and/or the like may define snap fittings. In still other embodiments, a magnet may be provided in either or both of the receiving space 120 and the interface portion of the end cap 130.

The level 100 may also include a vial assembly 140, which may be disposed at any portion (and sometimes include components disposed at multiple portions) of the housing 110. The vial assembly 140 may include one or more instances of a level vial that may be oriented and retained within the housing 110 such that the centering the bubble in the level vial indicates that the top face 116 and/or bottom face 118 is level (and therefor any surface supporting the housing 110 is also level). In some cases, the vial assembly 140 may also include one or more instances of a plumb vial that may be oriented and retained within the housing 110 such that the centering the bubble in the plumb vial indicates that the top face 116 and/or bottom face 118 is level (and therefor any surface to which the housing 110 is adjacent plumb).

Each vial in the vial assembly 140 may be a cylindrical vial with a liquid therein. The cylindrical vial may have a slightly elevated middle, so a bubble formed in the liquid will tend to sit in the middle of the vial, when the vial is oriented such that a corresponding portion of the housing 110 is level or plumb.

In an example embodiment, one or both instances of the end cap 130 may include a cleaning tool 150. The cleaning tool 150 may be incorporated into, or otherwise include, the interface portion mentioned above. However, in any case, the cleaning tool 150 may be entirely disposed in and contained in the receiving space 120 when the end cap 130 is attached to the housing 110. Moreover, in an example embodiment, the cleaning tool 150 may not be visible when retained in the receiving space 120.

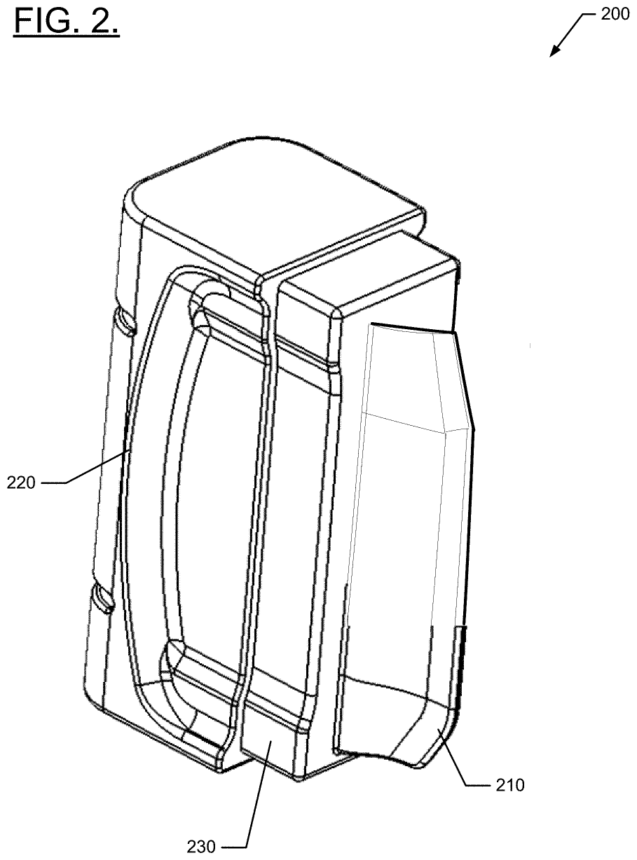

FIG. 2 illustrates one example implementation of the cleaning tool 150 of FIG. 1. In this regard, cleaning tool 200 is a wiping tool having a wiper 210 that is operably coupled to end cap 220, which is an example of the end cap 130 of FIG. 1. The operable coupling between the end cap 220 and the wiper 210 may be provided by interface portion 230. As noted above, the interface portion 230 may be configured to mate with the receiving space 120 of the housing 110. The wiper 210 of this example embodiment is rubber blade such as a squeegee. However, the wiper 210 could alternatively be made of cloth or other suitable materials for wiping.

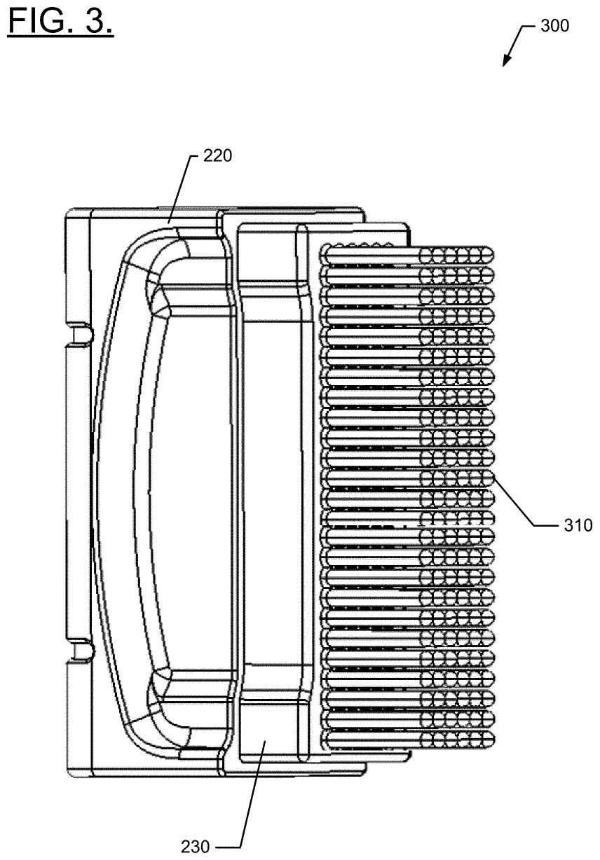

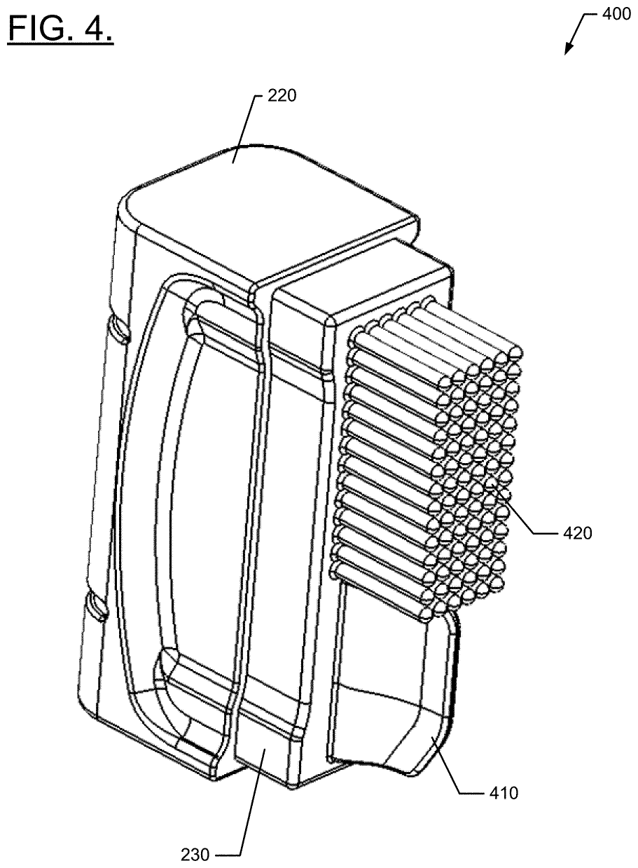

The cleaning system 150 may also take other forms. In this regard, for example, the cleaning tool 300 of FIG. 3 illustrates another distinct example of a different type of cleaning tool that may be employed in an example embodiment. The cleaning tool 300 of FIG. 3 also includes the end cap 220 of FIG. 2. However, in this example, a brush 310 replaces the wiper 210. The brush 310 (and consequently any bristles thereof) may be made of cloth, hair, plastic, rubber, or any other suitable material. As noted above, the cleaning tool 300 may be detachable relative to the housing 110 through the release of the end cap 220 via a magnetic, friction, or mechanical snap fit. However, in some examples, the end cap 220 may be retained to the housing 110 via a locking assembly (e.g., a latch, lock or the like). The end cap 220 may be molded, and the wiper 210 or brush 310 may be co-molded as one unitary component, or may be added to the end cap 220 as separate components. In some cases, one end cap 220 (e.g., at the first end 112) may include the wiper 210, and the other end cap 220 (e.g., at the second end 114) may include the brush 310. However, the cleaning tool 150 may alternatively incorporate both the wiper 210 and brush 310 into the same cleaning tool 150. FIG. 4 illustrates such an example.

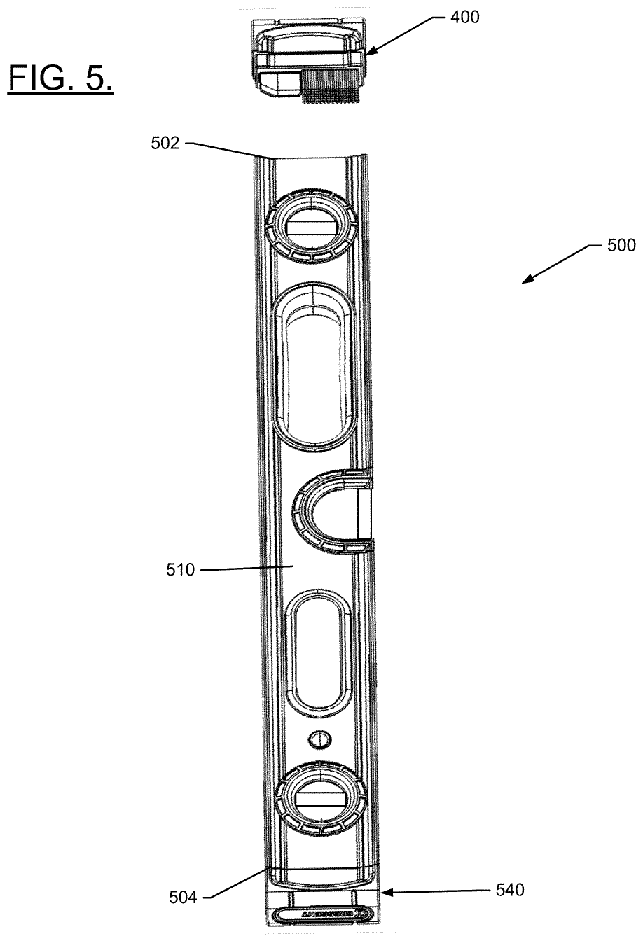

As shown in FIG. 4, a multi-purpose cleaning tool 400 of an example embodiment may include the end cap 220 and interface portion 230 of prior examples. However, the cleaning tool 400 further includes a wiper portion 410 and a brush portion 420. Thus, the cleaning tool 400 is configured with multiple (or different) types of cleaning structures. The cleaning tool 400 is shown in FIG. 5 poised for insertion into a level device 500. In this regard, a first end 502 of a housing 510 of the level device 500 is shown ready to receive the cleaning tool 400 of FIG. 4 therein. When the cleaning tool 400 is inserted into the first end 502, a seamless (or nearly seamless) fit with the housing 510. An example of such a seamless fit is shown by a second end cap 540 which is operably coupled to the second end 504 of the housing 510.

In an example embodiment, a level (e.g., a bubble level) may be provided. The device may include a housing having a top face, a bottom face, a first end and a second end. The housing may include a receiving space disposed at the first end. The device may further include a vial assembly and an end cap. The vial assembly may include one or more spirit or bubble levels disposed in the housing to indicate conditions of level or plumb relative to orientation of the top or bottom faces. The end cap may be configured to be removably retained in the receiving space. The end cap may include a cleaning tool disposed at a portion of the end cap and configured to be retained in the receiving space when the end cap is operably coupled to the level.

In some embodiments, the features of the device described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the cleaning tool may include a brush (e.g., made of plastic, hair, or cloth), or a wiper (e.g., a rubber blade or a squeegee). In some example embodiments, the cleaning tool may include a brush at a first portion thereof, and a wiper at a second portion thereof. In some cases, the cleaning tool may include at least two different types of cleaning devices. In an example embodiment, a second receiving space may be disposed at the second end, and a second end cap is retained in the second receiving space. In some cases, the cleaning tool may include at least two different types of cleaning devices, with one of the cleaning devices being disposed at the first end cap and the other of the cleaning devices being disposed at the second end cap. In an example embodiment, a brush may be disposed at the end cap of the first receiving space, and a wiper may be disposed at the second end cap to be retained in the second receiving space. In some cases, the end cap may include an interface portion configured to be retained in the receiving space via a friction fit therebetween. In an example embodiment, the end cap may include an interface portion configured to be retained in the receiving space via a magnet disposed at either or both of the interface portion and the receiving space. In some cases, the end cap and the cleaning tool may be co-molded together from the same material. In an example embodiment, the cleaning tool may be entirely contained within the receiving space when the end cap is mated with the housing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A level device comprising:
a housing having a top face, a bottom face, a first end and a second end, the housing comprising a receiving space disposed at the first end;
a vial assembly comprising one or more spirit or bubble levels disposed in the housing to indicate conditions of level or plumb relative to orientation of the top or bottom faces; and
an end cap configured to be removably retained in the receiving space,
wherein the end cap comprises a cleaning tool disposed at a portion of the end cap and configured to be retained in the receiving space when the end cap is operably coupled to the level.

2. The device of claim 1, wherein the cleaning tool comprises a brush.

3. The device of claim 2, wherein the brush is made of plastic, hair, or cloth.

4. The device of claim 1, wherein the cleaning tool comprises a wiper.

5. The device of claim 4, wherein the wiper is a squeegee.

6. The device of claim 1, wherein the cleaning tool comprises a brush at a first portion thereof, and a wiper at a second portion thereof.

7. The device of claim 1, wherein the cleaning tool comprises at least two different types of cleaning devices.

8. The device of claim 1, wherein a second receiving space is disposed at the second end, and a second end cap is retained in the second receiving space.

9. The device of claim 8, wherein the cleaning tool comprises at least two different types of cleaning devices, one of the cleaning devices being disposed at the first end cap and the other of the cleaning devices being disposed at the second end cap.

10. The device of claim 8, wherein a brush is disposed at the end cap of the first receiving space, and a wiper is disposed at the second end cap to be retained in the second receiving space.

11. The device of claim 1, wherein the end cap comprises an interface portion configured to be retained in the receiving space via a friction fit therebetween.

12. The device of claim 1, wherein the end cap comprises an interface portion configured to be retained in the receiving space via a magnet disposed at either or both of the interface portion and the receiving space.

13. The device of claim 1, wherein the end cap and the cleaning tool are co-molded together from the same material.

14. The device of claim 1, wherein the cleaning tool is entirely contained within the receiving space when the end cap is mated with the housing.

15. A removable end cap for a level device having a housing that comprises a receiving space disposed at an end portion of the housing, the end cap comprising:
an interface portion configured to mate with the receiving space; and
a cleaning tool operably coupled to the interface portion,
wherein the cleaning tool is configured to be retained entirely within the receiving space when the end cap is mated with the housing.

16. The end cap of claim 15, wherein the cleaning tool comprises a brush.

17. The end cap of claim 15, wherein the cleaning tool comprises a wiper.

18. The end cap of claim 15, wherein cleaning tool comprises a wiper portion and a brush portion.

19. The end cap of claim 15, wherein the cleaning tool and the interface portion are co-molded together from the same material.

20. The end cap of claim 15, wherein the interface portion is shaped to substantially match an inner profile of the receiving space to form a friction fit to hold the interface portion in the receiving space.
